(19) United States
(12) Patent Application Publication
(10) Pub. No.: US 2012/0312081 A1
(43) Pub. Date: Dec. 13, 2012

(54) High-Performance Liquid Chromatograph Apparatus and Method for Feeding Liquid to High-Performance Liquid Chromatograph Apparatus

(75) Inventors: Hiroshi Suzuki, Hitachinaka (JP); Masahito Ito, Hitachinaka (JP); Hroaki Nakagawa, Hitachinaka (JP)

(73) Assignee: Hitachi High-Technologies Corporation, Minato-ku Tokyo (JP)

(21) Appl. No.: 13/574,838

(22) PCT Filed: Feb. 2, 2011
(86) PCT No.: PCT/JP2011/053831

§ 371 Date: Jul. 24, 2012

(30) Foreign Application Priority Data
Mar. 1, 2010 (JP) 2010044332

(51) Int. Cl. G01N 30/84

(52) U.S. Cl. 73/61.55

(57) ABSTRACT

A high-performance liquid chromatograph apparatus of the present invention can obtain a similar separation effect as that obtained in a constant velocity gradient elution method and shorten a measuring time. When a data processor (13) generates a converted constant pressure gradient program based on a trace of past pressure values, a pressure value trace file stored in a pressure value trace storage unit (13a) is selected and displayed on a display and a pressure value is set. A constant pressure gradient program converting unit (13b) converts a constant velocity gradient program stored in a constant velocity gradient program storage unit (13c) to the constant pressure gradient program and numerals according to the converted constant pressure gradient program are displayed. A liquid feed part (5, 6) of a liquid feed pump (4) is controlled via a flow velocity setting unit (13d) and a mixing ratio setting unit (13e) according to the constant pressure gradient program displayed on the display.

### TECHNICAL FIELD

The present invention relates to a high-performance liquid chromatograph apparatus using the gradient elution method.

### BACKGROUND ART

In high-performance liquid chromatography, the gradient elution method that feeds a liquid by varying a mixing ratio of two or more types of eluents has been used in order to shorten a measuring time. A constant flow velocity is, however, generally used to prevent a peak shape from being aggravated.

An example of the high-performance liquid chromatograph apparatus using the gradient elution method is disclosed in patent document 1.

### PRIOR ART DOCUMENTS

### Patent Document

### Patent Document 1

WO2003-079000

### SUMMARY OF THE INVENTION

### Problem to be Solved by the Invention

Recent years have witnessed development of a separation column involving a packing material having an average particle size of about 2.5 micrometers or less, smaller than that of known separation columns. With the known separation column involving a packing material having a large particle size (about 5 micrometers), an increased flow velocity results in an aggravated peak shape. The separation column involving the packing material with a small particle size is characterized in that the peak shape is not substantially aggravated.

In the separation column involving a small packing material particle size, the higher the flow velocity, the shorter the measuring time with the peak shape maintained, as long as a pressure resistance range of the separation column is not exceeded.

With the known separation columns, an optimum flow velocity is set for each column and the separation column is not very often operated with the flow velocity widely deviated therefrom.

When the gradient elution method is employed using, for example, an aqueous solution or an organic solvent as an eluent, the pressure value varies during measurement according to a mixing ratio because of a unique viscosity each liquid has.

In the related art, the separation column involving a small packing material particle size is used in the gradient elution method with a constant flow velocity.

The constant flow velocity at this time is adjusted such that the pressure resistance of the separation column is not exceeded with reference to a point in time at which the pressure value is the greatest during the measurement.

Specifically, the related art is not concerned to shorten the measuring time by increasing the flow velocity to a level higher than the adjusted value.

It is an object of the present invention to achieve a high-performance liquid chromatograph apparatus capable of obtaining the same separation effect as in a constant velocity gradient elution method and shortening a measuring time. It is another object of the present invention to achieve a method for feeding a liquid to the high-performance liquid chromatograph apparatus.

### Means for Solving the Problem

To achieve the foregoing objects, one aspect of the present invention is configured as follows.

A high-performance liquid chromatograph apparatus according to the aspect of the present invention comprises: liquid feed means for feeing an eluent by varying a mixing ratio of two or more types of eluents; sample injecting means for injecting a sample into the eluent fed; a separation column configured to be supplied with the eluent into which the sample is injected and to thereafter separate a target component contained in the sample; a detector for analyzing the target component separated; and control means for controlling operation of the liquid feed means, the sample injecting means, the separation column, and the detector.

The control means includes: a constant velocity gradient program storage unit for storing a constant velocity gradient program that feeds the eluent at a constant velocity while varying the mixing ratio of two or more types of eluents; a constant pressure gradient program converting unit that converts the constant velocity gradient program to a constant pressure gradient program that feeds the eluent at a constant pressure while varying the mixing ratio of two or more types of eluents; and a flow velocity setting unit for controlling according to the converted constant pressure gradient program a flow velocity of the eluent fed.

### Effect of the Invention

In the aspect of the present invention, a high-performance liquid chromatograph apparatus capable of obtaining the same separation effect as in the constant velocity gradient elution method and shortening the measuring time, and a method for feeding a liquid to the high-performance liquid chromatograph apparatus can be both achieved.

### BRIEF DESCRIPTION OF THE DRAWINGS

FIG. 1 is a configuration diagram showing schematically a high-performance liquid chromatograph apparatus to which the present invention is applied.

FIG. 2 is an illustration showing an exemplary display screen of a data processor that sets a constant pressure gradient program according to the present invention.

FIG. 3 is a configuration diagram showing schematically internal functional blocks of the data processor that executes the constant pressure gradient program according to the present invention.

FIG. 4 is a chart showing a model of a constant velocity gradient program applied to the present invention.

FIG. 5 is a chart showing a model of a constant pressure gradient program according to the present invention.

FIG. 6 is an exemplary constant velocity gradient program incorporated in the present invention.

FIG. 7 is a graph showing a chromatogram obtained by measurement using the constant velocity gradient program shown in FIG. 6.

FIG. 8 is a graph showing a pressure value trace obtained by measurement using the constant velocity gradient program shown in FIG. 6.

FIG. 9 is a chart showing pressure values at different points in time extracted from FIG. 8, based on subdivision of the constant velocity gradient program shown in FIG. 6.

FIG. 10 is a chart showing data as converted from the constant velocity gradient program shown in FIG. 9 into a constant pressure gradient program.

FIG. 11 is a graph showing a chromatogram obtained by measurement using the constant pressure gradient program shown in FIG. 10.

FIG. 12 is a graph showing a pressure value trace obtained by measurement using the constant pressure gradient program shown in FIG. 10.

FIG. 13 is a flowchart showing general operations of a first embodiment of the present invention.

### MODES FOR CARRYING OUT THE INVENTION

An embodiment of the present invention will be described below with reference to the accompanying drawings.

### Embodiment

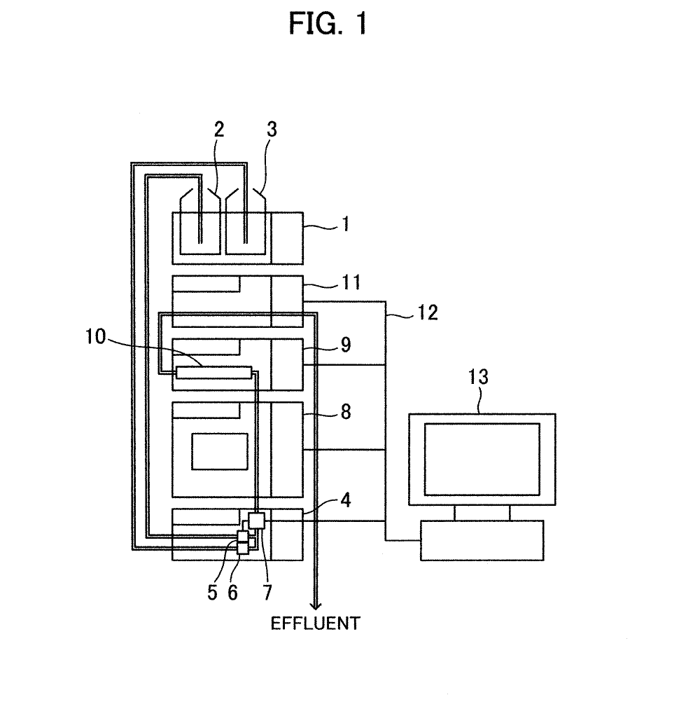

FIG. 1 is a configuration diagram showing schematically a high-performance liquid chromatograph apparatus to which the present invention is applied. Referring to FIG. 1, an eluent A 2 and an eluent B 3 loaded in a reagent rack 1 are fed to a sample injecting device 8 by a liquid feed part A 5 and a liquid feed part B 6, respectively, incorporated in a liquid feed pump 4. A syringe is typically used for the liquid feed parts 5, 6.

For the gradient elution method, a mixing ratio is adjusted by, for example, changing an operating speed of the liquid feed parts 5, 6. A pressure sensor 7 is usually built into a delivery side of the liquid feed pump 4 in order to determine a possible liquid feed failure or a plugged flow path. From the sample injected by the sample injecting device 8, a target component is separated by a separation column 10 disposed in a column oven 9 for maintaining a predetermined temperature and is then detected by a detector 11.

A data processor 13 is connected to each of different units (the liquid feed pump 4, the sample injecting device 8, the column oven 9, and the detector 11) using a signal cable 12. Not only controlling operation of each of these units, the data processor 13 records and saves signal strength from the detector 11 and pressure values from the pressure sensor 7. The data processor 13 also includes a display on which necessary information is displayed.

A packing material composed of a plurality of particles having an average particle size of about 2.5 micrometers or less is used in the separation column 10.

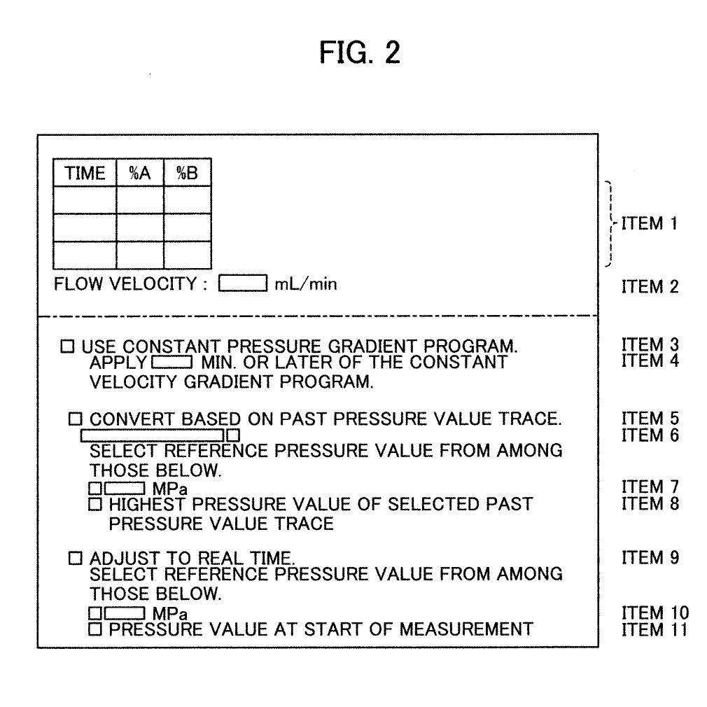

FIG. 2 is an illustration showing an exemplary setting screen displayed on the data processor 13 when a constant pressure gradient program is to be used.

Referring to FIG. 2, a constant velocity gradient program which a user input at random is input in item 1 and item 2. In the example shown in FIG. 2, ratios of the eluent A and the eluent B relative to elapsed time, and the flow velocity can be set.

The user's selecting item 3 allows use of the constant pressure gradient program to be selected. At the same time, inputting any numeral in item 4 determines a specific stage (point in time) of the constant velocity gradient program from which the constant pressure gradient program is to be applied.

When the constant velocity gradient program is to be converted to a corresponding constant pressure gradient program based on a pressure value trace obtained in measurement taken in the past using the constant velocity gradient program, select item 5 and select a pressure trace file on which to base in item 6. Next, input item 7 or item 8. This allows a reference pressure value or the highest pressure value of the past pressure value trace to be determined.

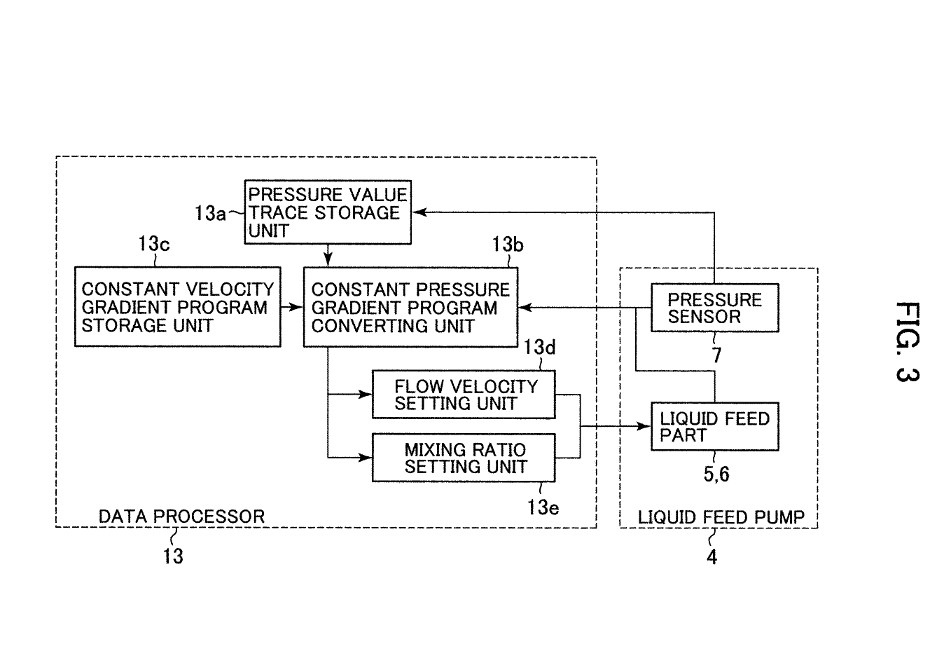

FIG. 3 schematically shows operating functions of the embodiment of the present invention achieved internally the data processor 13.

Referring to FIG. 3, when the constant velocity gradient program is to be converted to a corresponding constant pressure gradient program based on the pressure value trace obtained in measurement taken in the past using the constant velocity gradient program, information on the pressure value trace stored in a pressure value trace storage unit 13a and on the constant velocity gradient program stored in a constant velocity gradient program storage unit 13c is transmitted to a constant pressure gradient program converting unit 13b.

Operation of the converted constant pressure gradient program is performed by the liquid feed parts 5, 6 via a flow velocity setting unit 13d and a mixing ratio setting unit 13e.

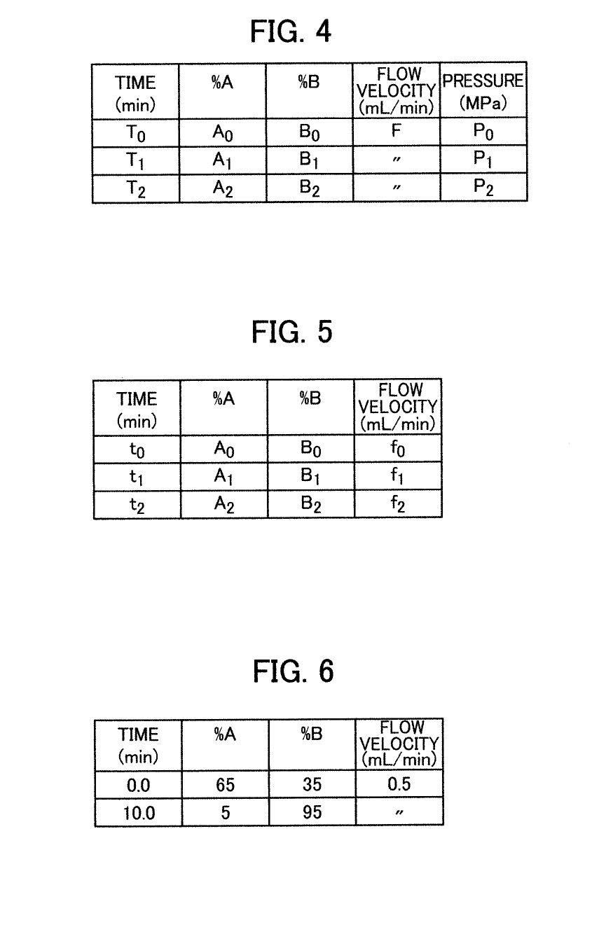

FIG. 4 is a chart showing a model that describes an actually measured pressure value at each time interval by which the constant velocity gradient program is subdivided. FIG. 5 is a chart showing a model of the constant velocity gradient program converted to a corresponding constant pressure gradient program.

Referring to FIGS. 4 and 5, a flow velocity fₘ of the constant pressure gradient program is calculated using an expression (1) given below.

fₘ=F·{(Pₛ or Pₘₐₓ)/Pₘ} (1)

where, m denotes a numeral of 0 or more, F denotes a constant flow velocity, Pₛ denotes any pressure value determined by the user based on, for example, a column pressure resistance guaranteed value, Pₘₐₓ denotes a maximum pressure value in the constant velocity gradient program, and Pₘ denotes an actually measured pressure value.

Next, time tₙ in the constant pressure gradient program is calculated using an expression (2) given below.

tₙ=tₙ₋₁+F·(Tₙ−Tₙ₋₁)/{(fₙ₋₁+fₙ)/2} (2)

where, in the above expression (1), n denotes a numeral of 1 or more, Tₙ and Tₙ₋₁ are time in the constant velocity gradient program, and fₙ₋₁ and fₙ are flow velocities after conversion to the constant pressure gradient program.

Preferably, the constant velocity gradient program is subdivided by as short a time interval as possible. The constant velocity gradient program may even be subdivided by an amount of change in pressure, instead of the time interval.

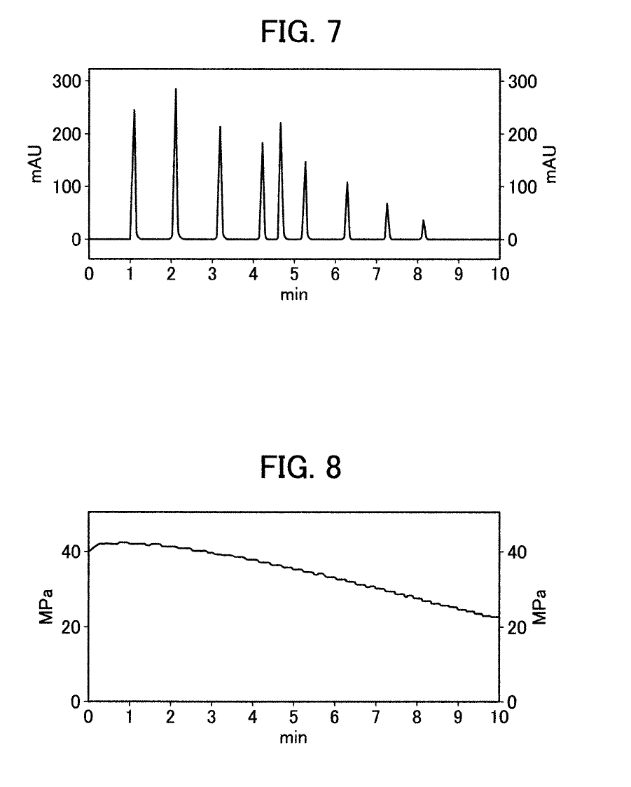

FIG. 6 is a chart showing exemplary measurement taken with the constant velocity gradient program. FIG. 7 is a chromatogram obtained by measurement using the constant velocity gradient program shown in FIG. 6. FIG. 8 shows a pressure value trace obtained at that time.

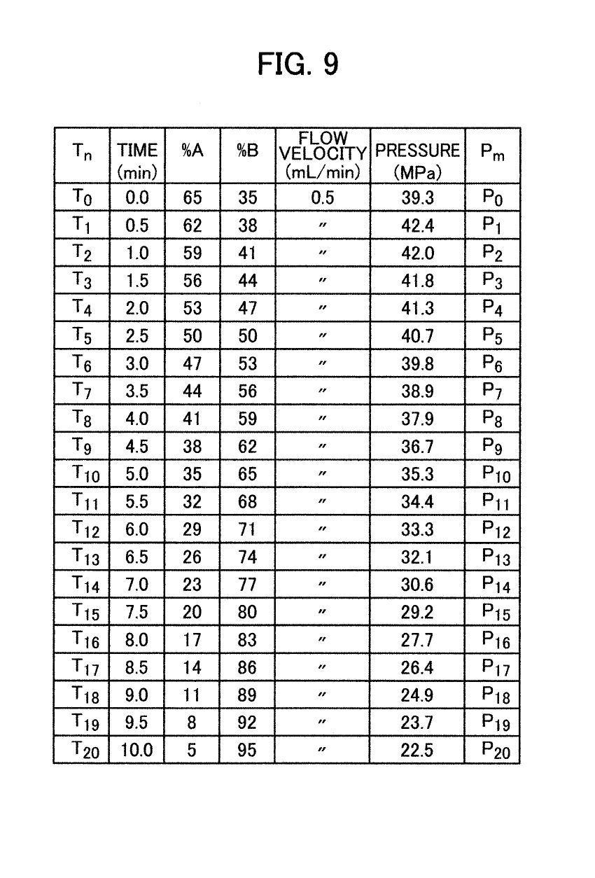

FIG. 9 is a chart that describes pressure values at different points in time extracted from FIG. 8, based on subdivision of the constant velocity gradient program shown in FIG. 6 by time intervals of 0.5 min.

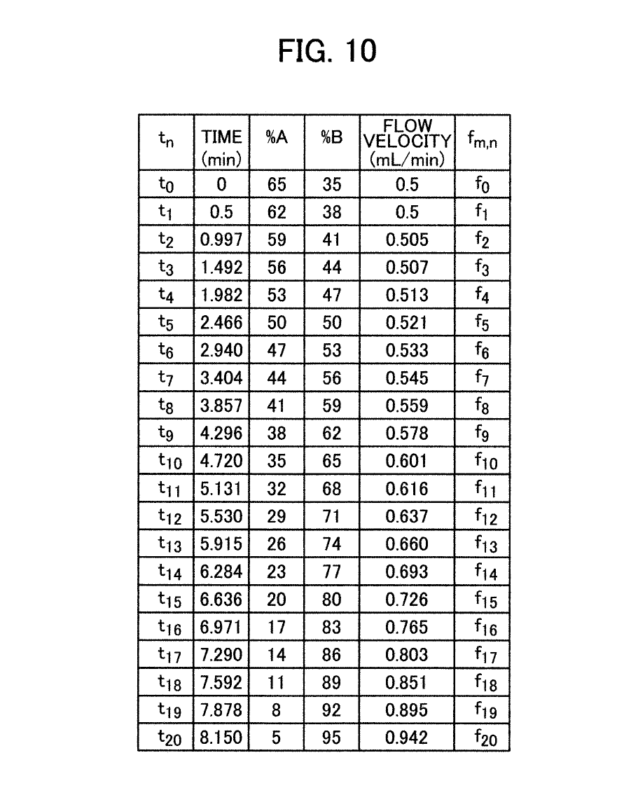

FIG. 10 is a chart showing data converted from the constant velocity gradient program into the constant pressure gradient program using the above-noted expressions (1) and (2) based on the highest pressure value of the pressure value trace of 0.5 min. and later. Time it takes for the measurement with the constant velocity gradient program 10 min. as shown in FIG. 9 is reduced to 8.15 min. with the constant pressure gradient program as shown in FIG. 10.

The measurement with the constant velocity gradient program and that with the constant pressure gradient program are determined to be completed when all of a scheduled flow liquid amount is fed. Specifically, the specific point in time at which the scheduled flow liquid amount is fed is 10 min. for the constant velocity gradient program and 8.15 min. for the constant pressure gradient program.

The charts shown in FIGS. 9 and 10 may be displayed on the display of the data processor 13 so that elapsed time in measurement when the constant velocity gradient program is converted to the constant pressure gradient program can be estimated.

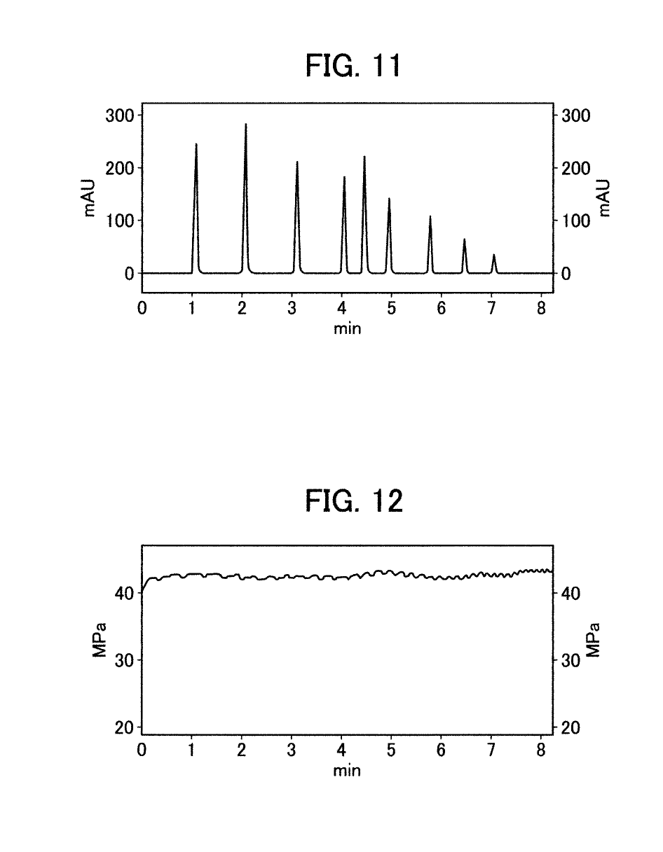

FIG. 11 shows a chromatogram obtained by measurement using the constant pressure gradient program converted from the constant velocity gradient program. FIG. 12 is a graph showing a pressure value trace obtained by measurement using the converted constant pressure gradient program. As shown in FIG. 12, the pressure values remain substantially constant, with some pulsations, throughout the measurement, suggesting that a similar separation effect (FIG. 11) as that obtained in the constant velocity gradient program can be obtained.

It is noted that, in constant acceleration liquid feed, a liquid feed amount changes in a quadratic function manner. If control by the high-performance liquid chromatograph apparatus is enabled, in order to achieve even more strict conversion from the constant velocity gradient program to the constant pressure gradient program, preferably an eluent mixing ratio Bₓ for a period of time from tₚ to tₚ₊₁ (predetermined time interval) in the constant pressure gradient program is varied in a quadratic function manner using, for example, an expression (3) given below.

Bₓ=Bₚ+[fₚ·(tₓ−tₚ)+(tₓ−tₚ)·{(fₚ₊₁−fₚ)/(tₚ₊₁−t₁)}·(tₓ−tₚ)/2]/{F·(Tₚ₊₁−Tₚ)}·(Bₚ₊₁−Bₚ) (3)

where, Bₚ₊₁ and Bₚ denote eluent mixing ratios in the constant velocity gradient program, fₚ and fₚ₊₁ denote flow velocities after conversion, tₓ denotes present time, Tₚ and Tₚ₊₁ denote times in the constant velocity gradient program, and t₁ denotes time after a lapse of predetermined period of time since the start of measurement (e.g. 0.5 min.).

An adjustment (program conversion) based on pressure values measured on a real-time basis, instead of conversion to the constant pressure gradient program based on the past pressure value trace data, will be described below.

For the adjustment on a real-time basis, select item 9 of FIG. 2 and input item 10 (a specifically specified pressure value) or item 11 (pressure value at the start of measurement) for the reference pressure value.

Operation in this case will be described.

Information on a pressure value at a current point in time measured with the pressure sensor 7 shown in FIG. 3 and on the constant velocity gradient program stored in the constant velocity gradient program storage unit 13c is transmitted to the constant pressure gradient program converting unit 13b.

The constant pressure gradient program converting unit 13b adjusts the flow velocity at the liquid feed part 5, 6 via the flow velocity setting unit 13d so as to achieve the reference pressure value set in item 10 or item 11 of FIG. 2.

In parallel, the constant pressure gradient program converting unit 13b calculates a total liquid feed amount since the start of the measurement based on, for example, a motor speed of the liquid feed pump 4. For example, if the total liquid feed amount is 10 mL, the liquid feed part 5, 6 is adjusted via the mixing ratio setting unit 13e such that a mixing ratio at 10 min. is achieved in the constant velocity gradient program at a flow velocity of 1 mL/min.

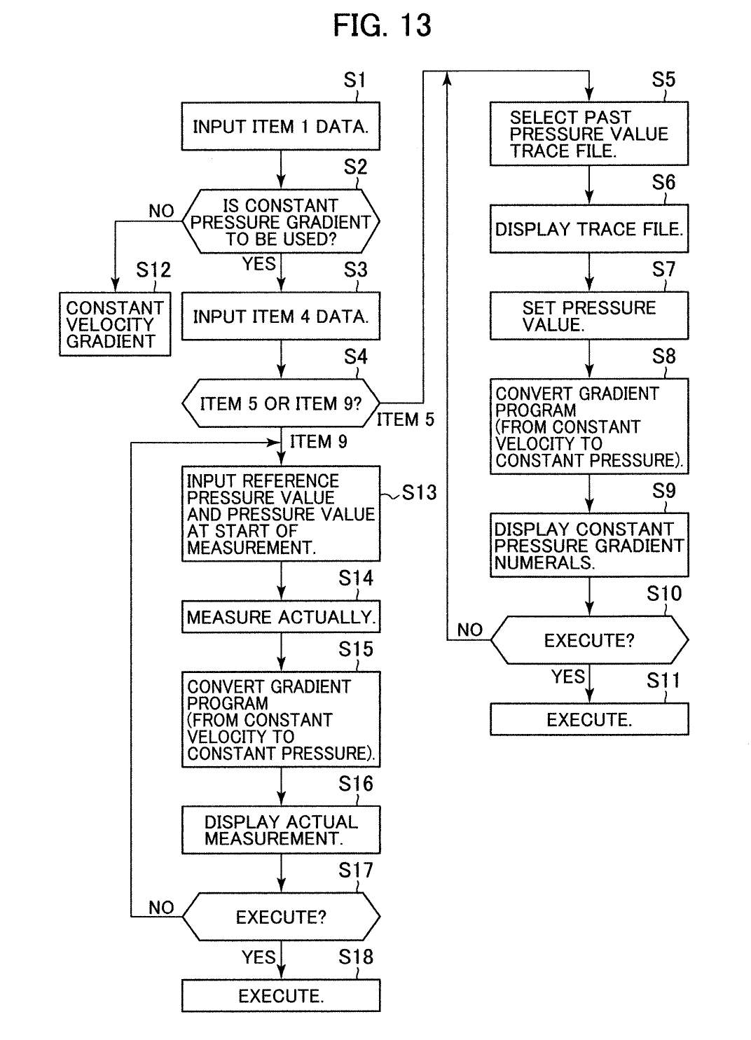

A flowchart of general operations described above is shown in FIG. 13. The data processor 13 controls different units to let them perform these operations.

In step S1 of FIG. 13, data of items 1 and 2 of FIG. 2 is input. Next, in step S2, it is determined whether the constant pressure gradient program is to be used. If it is determined that the constant pressure gradient program is not to be used, the operation proceeds to step S12 and the constant velocity gradient program is performed.

If it is determine in step S2 that the constant pressure gradient program is to be used, the operation proceeds to step S3 and data of item 4 shown in FIG. 2 is input. In step S4, it is selected that conversion from the past pressure values to the constant pressure gradient program is made based on a trace (item 5) or made based on pressure values measured on a real-time basis (item 9).

If it is selected in step S4 to convert the past pressure values to the constant pressure gradient program based on the trace (item 5), the operation proceeds to step S5. The past pressure value trace file is then selected. The selected trace file is now displayed on the display (step S6) and the pressure value is set (step S7).

Next, the constant velocity gradient program is converted to the constant pressure gradient program (step S8) and numerals according to the converted constant pressure gradient program (FIG. 10) are displayed on the display.

It is then determined whether to execute the numerals according to the constant pressure gradient program (step S10). If it is determined that execution is practical, the operation proceeds to step S11 and the numerals are executed.

If it is determined in step S10 that execution of the numerals displayed is not desired, the operation returns to step S5 and starts over from the selection of the pressure value trace file.

If item 9 is selected in step S4, the operation proceeds to step S13 and the reference pressure value and the pressure value at the start of measurement are input. Actual measurement is then taken (step S14) and the constant velocity gradient program is converted to the constant pressure gradient program based on the actual measurement (step S15).

Then in step S16, the actual measurement is displayed on the display. It is then determined whether execution by the displayed numerals is desired (step S17). If the execution is practical, the operation proceeds to step S18 and the displayed numerals are executed.

If it is determined that the execution by the displayed numerals is not desired in step S17, the operation returns to step S13 and starts over from the input of the reference pressure value and other data.

As described heretofore, in the embodiment of the present invention, the flow velocity of the eluent is controlled so as to achieve an optimum maximum pressure. Therefore, if a separation column involving a packing material having a small particle size (the average particle size should be about 2.5 micrometers) is used, the flow velocity of the eluent can be increased within the range of the maximum pressure, so that the analyzing time can be reduced. With the separation column involving a small packing material particle size, a predetermined level of or better peak shape can be maintained even with an increased flow velocity as long as the pressure resistance of the separation column is not exceeded.

In the first embodiment of the present invention, therefore, a high-performance liquid chromatograph apparatus capable of obtaining the same separation effect as in the constant velocity gradient elution method and shortening the measuring time can be achieved, and a method for feeding a liquid to the high-performance liquid chromatograph apparatus can be achieved.

It is noted that continued use of the separation column results in gradual clogging of dust contained in the sample or the eluent, resulting in an increased pressure value even if the eluent of the same composition is fed at the same flow velocity.

If measurement is taken through conversion to the constant pressure gradient program on a real-time basis, therefore, the peak elution time delays. To obtain reproducibility of the elution time, the following measurement approach may be taken. Specifically, the program is converted on a real-time basis for a first session and changes in the flow velocity and mixing ratio during that period are recorded; for subsequent sessions, the pressure value at the current point in time is not fed back and, instead, previously recorded changes in the flow velocity and the mixing ratio are reproduced.

Most preferably, the present invention is applied to the high-performance liquid chromatograph apparatus that incorporates the separation column involving a packing material having a small particle size (the average particle size is about 2.5 micrometers). The present invention is nonetheless applicable also to a liquid chromatograph apparatus incorporating a separation column involving a packing material having an ordinary particle size (the average particle size is about 5.0 micrometers).

For the separation column involving the packing material having the ordinary particle size, an increased flow velocity of the eluent may aggravate the peak shape, but can reduce the measuring time.

The separation column involving the packing material having the ordinary particle size is suitable if short measurement time is desired even with poor measuring accuracy.

It is noted that aggravation of the peak shape may be improved by appropriate software processing.

### DESCRIPTION OF REFERENCE CHARACTERS

1: Reagent rack
2: Eluent A
3: Eluent B
4: Liquid feed pump
5: Liquid feed part A
6: Liquid feed part B
7: Pressure sensor
8: Sample injecting device
9: Column oven
10: Separation column
11: Detector
12: Signal cable
13: Data processor
13a: Pressure value trace storage unit
13b: Constant pressure gradient program converting unit
13c: Constant velocity gradient program storage unit
13d: Flow velocity setting unit
13e: Mixing ratio setting unit

1. A high-performance liquid chromatograph apparatus comprising:
liquid feed means (4) for feeing an eluent by varying a mixing ratio of two or more types of eluents;
sample injecting means (8) for injecting a sample into the eluent fed from the liquid feed means (4);
a separation column (10) configured to be supplied with the eluent into which the sample is injected by the sample injecting means (8) and to thereafter separate a target component contained in the sample;
a detector (11) for analyzing the target component separated by the separation column (10); and
control means (13) for controlling operation of the liquid feed means (4), the sample injecting means (8), the separation column (10), and the detector (11), the control means (13) including:
a constant velocity gradient program storage unit (13c) for storing a constant velocity gradient program that feeds the eluent at a constant velocity while varying the mixing ratio of two or more types of eluents;
a constant pressure gradient program converting unit (13b) that converts the constant velocity gradient program to a constant pressure gradient program that feeds the eluent at a constant pressure while varying the mixing ratio of two or more types of eluents; and
a flow velocity setting unit (13d) for controlling a flow velocity of the eluent fed by the liquid feed means (4) according to the constant pressure gradient program converted by the constant pressure gradient program converting unit (13b).

2. The high-performance liquid chromatograph apparatus according to claim 1, further comprising:
a pressure sensor (7) for measuring pressure of the eluent fed from the liquid feed means (4), wherein:
the control means (13) further includes a pressure value trace storage unit (13a) for storing a pressure value measured by the pressure sensor (7); and
the constant pressure gradient program converting unit (13b) of the control means (13) converts the constant velocity gradient program to the constant pressure gradient program based on the pressure value stored in the pressure value trace storage unit (13a).

3. The high-performance liquid chromatograph apparatus according to claim 1, further comprising:
a pressure sensor (7) for measuring pressure of the eluent fed from the liquid feed means (4), wherein
the control means (13) converts the constant velocity gradient program to the constant pressure gradient program based on a current pressure value measured by the pressure sensor (7) and an amount of eluent fed by the liquid feed means (4).

4. The high-performance liquid chromatograph apparatus according to claim 2, wherein:
the constant velocity gradient program storage unit (13c) stores a plurality of constant velocity gradient programs;
the control means (13) includes a setting unit (13d) in which one of the constant velocity gradient programs and a flow velocity are set; and
the constant pressure gradient program converting unit (13b) converts the constant velocity gradient program to the constant pressure gradient program based on the constant velocity gradient program and the flow velocity that are set in the setting unit (13d).

5. The high-performance liquid chromatograph apparatus according to claim 4, wherein:
in the setting unit (13d), time at which the constant pressure gradient program is to be applied is set; and
the control means (13) controls the flow velocity of the eluent fed by the liquid feed means (4) according to the converted constant pressure gradient program effective after the set time.

6. The high-performance liquid chromatograph apparatus according to claim 2, wherein
the control means (13) includes a display and causes the display to display data showing a relationship among elapsed time according to the converted constant pressure gradient program, the eluent mixing ratio, and the flow velocity.

7. The high-performance liquid chromatograph apparatus according to claim 3, wherein
the control means (13) includes a display and causes the display to display a current pressure value measured by the pressure sensor (7).

8. The high-performance liquid chromatograph apparatus according to claim 1, wherein
the separation column (10) uses a packing material comprising a plurality of particles, each particle having an average particle size of about 2.5 micrometers or less.

9. A method for feeding a liquid to a high-performance liquid chromatograph apparatus that feeds an eluent by varying a mixing ratio of two or more types of eluents, injects a sample into the eluent fed, supplies the eluent into which the sample has been injected to a separation column (10), separates a target component contained in the sample, and analyzes using a detector (11) the target component separated, the method comprising the steps of:
storing a constant velocity gradient program that feeds the eluent at a constant velocity while varying the mixing ratio of two or more types of eluents;
converting the constant velocity gradient program to a constant pressure gradient program that feeds the eluent at a constant pressure while varying the mixing ratio of two or more types of eluents; and
controlling according to the converted constant pressure gradient program a flow velocity of the eluent to be fed.

10. The method for feeding a liquid to a high-performance liquid chromatograph apparatus according to claim 9, further comprising the steps of:
measuring pressure of the eluent fed; and
storing a pressure value measured, wherein
the constant velocity gradient program is converted to the constant pressure gradient program based on the pressure value stored.

11. The method for feeding a liquid to a high-performance liquid chromatograph apparatus according to claim 9, further comprising the step of:
measuring pressure of the eluent fed, wherein
the constant velocity gradient program is converted to the constant pressure gradient program based on a current pressure value measured and an amount of eluent fed.

12. The method for feeding a liquid to a high-performance liquid chromatograph apparatus according to claim 10, further comprising the step of:
storing a plurality of constant velocity gradient programs, wherein:
one of the constant velocity gradient programs and a flow velocity are set; and
the constant velocity gradient program is converted to the constant pressure gradient program based on the set constant velocity gradient program and the set flow velocity.

13. The method for feeding a liquid to a high-performance liquid chromatograph apparatus according to claim 12, wherein:
time at which the constant pressure gradient program is to be applied is set; and
the flow velocity of the eluent fed by liquid feed means (4) is controlled according to the converted constant pressure gradient program effective after the set time.

14. The method for feeding a liquid to a high-performance liquid chromatograph apparatus according to claim 10, wherein
data showing a relationship among elapsed time according to the converted constant pressure gradient program, the eluent mixing ratio, and the flow velocity is displayed on a display.

15. The method for feeding a liquid to a high-performance liquid chromatograph apparatus according to claim 11, wherein
the measured current pressure value is displayed on the display.

16. The method for feeding a liquid to a high-performance liquid chromatograph apparatus according to claim 9, wherein
the separation column (10) uses a packing material comprising a plurality of particles, each particle having an average particle size of about 2.5 micrometers or less.
